(19) United States
(12) Patent Application Publication
(10) Pub. No.: US 2012/0284158 A1
(43) Pub. Date: Nov. 8, 2012

(54) ZERO-LATENCY RISK-MANAGEMENT SYSTEM AND METHOD

(75) Inventor: Peter Joseph Kovac, Santa Monica, CA (US)

(73) Assignee: Madison Tyler, LLC., Santa Monica, CA (US)

(21) Appl. No.: 13/101,327

(22) Filed: May 5, 2011

(51) Int. Cl. G06Q 40/00

(52) U.S. Cl. 705/37

(57) ABSTRACT

A zero-latency risk-management system and method useful in, for example, sponsored market access or in-house trades. The zero-latency risk-management system comprises an out-of-band risk monitor computer and a kill-switch. The kill-switch is in-line between order receipt and trade placement, but the out-of-band risk monitor computer operates in parallel with the order processing, thus eliminating latency in the trade. The out-of-band risk computer monitors orders as they flow through the system and updates any risk metrics based on those orders. Kill-switch threshold levels may be set in the risk computer to be, for example, the desired level of risk, minus the maximum amount of risk that a subsequent new order could incur. If the risk computer determines that an order has breached this kill-switch threshold, it activates the kill-switch to prevent additional order entry that could breach the actual threshold.

### TECHNICAL FIELD

The present invention relates to a risk-management system and method for financial markets and futures contracts for tradable assets, such as commodities or other financial instruments. More particularly, the invention relates to a system and method for providing a zero-latency risk-management system that would be useful to financial markets and tradable assets.

### BACKGROUND

In the financial world, trading firms and brokers are tirelessly seeking to reduce the time between the generation or receipt of an order (e.g., a request to buy a stock or other commodity) and the placement of said order with the appropriate market or exchange, such as, for example, the New York Stock Exchange (“NYSE”), New York Mercantile Exchange (“NYMEX”), NASDAQ Stock Market (“NASDAQ”, formerly known as the “National Association of Securities Dealers Automated Quotations”), the Chicago Mercantile Exchange (“CME”) and countless U.S. and foreign exchanges that trade stocks, commodities, swaps, currencies, and/or futures contracts. Generally speaking, a futures contract is a standardized contract between two parties to buy or sell a specified asset, typically utilizing an underlying instrument as a commodity, such as crude oil, metals, agricultural products, etc. For example, the NYMEX has two standard types of futures contracts for light sweet crude oil: known as the West Texas Intermediate (“WTI”) contract and the Brent contract. In some instances, the underlying assets to futures contracts may not be traditional commodities. For example, the underlying assets in financial futures may be currencies, securities, financial instruments, intangible assets, or referenced items such as stock indexes and interest rates.

Regardless of the asset, computer systems and networks are increasingly being used to automate trades because they provide several advantages over manual methods. Such advantages include, for example, increased accuracy, reduced labor costs, the ability to quickly disseminate market information and, most importantly, reduced latency. Reduced latency (i) decreases the chance that the market will move against an investor in the time between the origination of the order and its receipt at the exchange, (ii) decreases risk by permitting investors to quickly and precisely hedge their market exposure or lock in gains, and (iii) increases the likelihood of orders executing on “price-time” exchanges where the first orders received at a given price have a higher priority and are executed first. High-performance networks, sophisticated programming techniques, hardware acceleration, and real-time analytics are some additional technologies that allow businesses to shorten the latency between the placement and the exchange's receipt of an order. In fact, to expedite trades, some companies place their servers directly on the floor of the stock exchange or “co-locate” with the exchange's own computers, effectively giving them direct pipes into the trading platform. In addition, some companies even use microprocessors designed for video games to more quickly process the market data that enters their systems and models. For further information on the importance of speed in the trading environment, see Paul Barsch's article entitled “Zero Latency: The Next Arms Race,” available at http://paulbarsch.wordpress.com/2009/07/29/zero-latency-the-next-arms-race/.

Handling an incoming order, however, does not simply involve receiving an order and submitting the order to the market or exchange. The order must be evaluated to assess its risk and to determine whether the order should be placed, based on preset parameters.

Generally speaking, a trading firm that wishes to interact electronically with a market can do so in one of three ways. The first is often referred to as “filtered access,” whereby trading firms trade through a third-party broker's systems by transmitting their orders to the broker's systems, which relay them to the markets. The trades are typically cleared (e.g., the terms of the trade are contractually committed to) by a broker who maintains an account for the trading firm, so the broker ultimately bears any financial responsibility for the trading firm's activity (i.e., if the trading firm assumes a risky position and goes bankrupt, the broker may cover the losses with counterparties). A second method is often referred to as “unfiltered access,” whereby a trading firm trades directly with the market, but clears orders through the broker by transmitting orders to the exchanges using the broker's market identifier (“MPID”) in order to bypass the broker's systems. While MPIDs may only pertain to U.S. trading, international MPID equivalents may exist and, for the purpose of this application, should be considered to be incorporated into the definition of MPID. As with “filtered access,” these trades are cleared by a broker who maintains an account for the trading firm and who ultimately bears the financial responsibility for the trading firm's activity. The third option is “direct access,” whereby a trading firm trades directly with the market so that orders clear using the trading firm's account. This may be accomplished by transmitting orders to an exchange using the trading firm's MPID, which designates the trades to clear with the trading film. In this case, the trading firm must have both a license and the operational capability to clear the trades.

Currently, many firms prefer the second method (sponsored-access arrangements) because it grants a trading firm access to a market using the broker's MPID without requiring the broker to employ a filter on that access. Trading firms that use third-party brokers to clear orders often prefer “unfiltered” access over “filtered” access because filtered access introduces additional delays into order placement and delays increase risk in the manner described above. However, recent regulations may significantly increase the difficulty of engaging in “unfiltered access” and may possibly eliminate this option completely.

For instance, on Nov. 3, 2010, the Securities and Exchange Commission (“SEC” or the “Commission”) adopted a market-access rule (“Rule 15c3-5”) for broker-dealers trading directly on an exchange or an alternative trading system (“ATS”). The market-access rule applies to broker-dealers with direct market access engaged in proprietary trading as well as firms that provide market access to customers (i.e., it applies to both direct and sponsored access). Under Rule 15c3-5, all broker-dealers with market access must have risk management controls and supervisory procedures designed to manage the financial, regulatory, and other risks arising from such access.

The market-access rule requires that the risk controls be implemented on a pre-trade, automated basis. The SEC is particularly concerned about the quality of broker-dealer risk controls in sponsored access arrangements, whereby the customer order flow does not pass through the broker-dealer's systems prior to its entry on an exchange or ATS. The market-access rule requires pre-trade controls to be in place in order to prevent, for example, erroneous orders, potential violations of credit or capital limits, or a failure to comply with SEC or exchange trading rules.

Rule 15c3-5 applies to trading in all securities on an exchange or ATS, including equities, options, exchange-traded funds, and debt securities—the compliance date being Jul. 14, 2011. The SEC's rule requires broker-dealers with market access to have financial-risk management controls designed to (1) prevent the entry of orders that exceed preset credit or capital thresholds and, if appropriate, more finely tuned thresholds by sector, security, or otherwise and (2) prevent erroneous orders by rejecting orders that exceed price or size parameters or that indicate duplicative orders. For further information on Rule 15c3-5, see Risk Management Controls for Brokers and Dealers with Market Access, Exchange Act Release No. 63241 (Nov. 3, 2010), 75 Fed. Reg. 69792 (Nov. 15, 2010) and Exchange Act Release No. 61379 (Jan. 19, 2010), 75 Fed. Reg. 4007 (Jan. 26, 2010).

To mitigate risk, some firms have turned to services such as NASDAQ's Pre-Trade Risk Management (“PRM”), which provides member firms with the ability to set a wide range of parameters for orders to facilitate pre-trade protection. Using PRM, member firms can increase controls on the trading activity of their clients and their customers at the order level, thereby reducing the risk of executing erroneous transactions. However, services such as NASDAQ's overall film credit checks suffer from the inherent limitation that they cannot incorporate activity on other exchanges and therefore cannot evaluate a firm's total risk. For further information on NASDAQ's PRM, see NASDAQ's web site, available at http://www.nasdaqtrader.com/Trader.aspx?id=PRM. In other instances, firms have relied upon slower “filtered access” systems which have the drawbacks described in greater detail below.

Therefore, a need exists for a more efficient risk-management design that addresses these problems by providing a zero-latency risk-management system.

### SUMMARY OF THE INVENTION

The present application discloses a system and method for providing a zero-latency risk-management system.

In a first aspect, the present invention is directed to a system for providing zero latency risk monitoring comprising: (i) a component for receiving or generating an order; (ii) a gateway for communicating an order into a market, based on the received or generated order; (iii) an out-of-band risk monitoring computer for monitoring the processing of the received or generated order in real time, calculating a risk parameter corresponding to the received or generated order, and updating the risk parameter; and (iv) a kill-switch positioned in-line between said component and said gateway and coupled to said computer, for preventing orders from reaching the market based on the updated risk parameter.

In a second aspect, the present invention is directed to a computer implemented method for providing zero latency risk monitoring comprising: receiving or generating an order; placing an order in a market, the order corresponding to the received or generated order; monitoring processing of the order in real time; using an out-of-band computer to calculate a real-time risk parameter corresponding to the monitored order; updating the calculated real-time risk parameter; and determining based on the updated real-time risk parameter whether to prevent orders from reaching the market.

In a third aspect, the present invention is directed to a processor-based apparatus for providing zero latency risk monitoring comprising: (i) a component for receiving an order; (ii) a gateway for communicating an order into a market, based on the received order; (iii) an out-of-band risk monitoring computer for monitoring the processing of the received order in real time, calculating a risk parameter corresponding to the received order, and updating the risk parameter; and (iv) a kill-switch positioned in-line between said component and said gateway and coupled to said computer, for preventing orders from reaching the market based on the updated risk parameter.

In a fourth aspect, the present invention is directed to a processor-based system for providing zero latency risk monitoring comprising: (i) a component for receiving or generating an order; (ii) a gateway for communicating an order into a market, based on the received or generated order; (iii) an out-of-band risk monitoring computer for monitoring the processing of the received or generated order in real time, calculating a risk parameter corresponding to the received or generated order, and updating the risk parameter; (iv) a kill-switch positioned in-line between said component and said gateway and coupled to said computer, for preventing orders from reaching the market; and (v) a secondary connection capable of bypassing an enabled kill-switch for communicating an order to a gateway for entry into an exchange, wherein an in-line risk management system enabled to calculate and update a risk parameter evaluates the order prior to communication to said gateway.

In a fifth aspect, the present invention is directed to a computer implemented method for providing zero latency risk monitoring comprising: receiving or generating an order; placing an order in a market, the order corresponding to the received or generated order; monitoring processing of the order in real time; using an out-of-band computer to calculate a real-time risk parameter corresponding to the monitored order; updating the calculated real-time risk parameter; determining based on the updated real-time risk parameter whether to prevent orders from reaching the market, and optionally trigger a gateway cancel-on-disconnect operation of a kill-switch positioned in-line between the receiving step and the placing step; evaluating a second order using an in-line risk management system enabled to calculate and update a real-time risk parameter; and communicating the second order to a gateway for entry into a market via a secondary connection capable of bypassing an enabled kill-switch.

In a sixth aspect, the present invention is directed to a system for providing zero latency risk monitoring comprising: (i) a component for receiving or generating an order; (ii) an out-of-band risk monitoring computer for monitoring the processing of the received or generated order in real time, calculating a risk parameter corresponding to the received or generated order, and updating the risk parameter; and (iii) a kill-switch positioned in-line between said component and a market and coupled to said computer, for preventing orders from being executed in the market based on the updated risk parameter.

In certain aspects, a warning signal may be used to indicate the occurrence of an event, including, for example, (i) a gateway cancel-on-disconnect; (ii) meeting or exceeding a preset warning threshold; (iii) order cancelation; (iv) rerouting an order; (v) communicating a termination signal; (vi) selectively blocking or filtering subsequent network packets; or (vii) combinations thereof. The warning signal may be communicated via a processor-based device. A processor-based device may be, for example, a portable phone, a smart phone, or a computer. The kill-switch may be enabled to execute, trigger, or otherwise prompt an operation chosen from a list of operations comprising (i) a gateway cancel-on-disconnect operation; (ii) rerouting an order to an in-line risk monitoring system via the secondary connection; (iii) communicating a termination signal to a market center; (iv) selectively blocking or filtering subsequent network packets; or (v) one or more combinations thereof. The operation may be triggered when the difference between the updated risk parameter and a maximum risk parameter is less than or equal to a maximum risk parameter that may be incurred by the next order. Although a gateway cancel-on-disconnect can improve the zero-latency risk-management system, a cancel-on-disconnect may not always be part of a market center's operations, and may be triggered by the market center or a termination signal from an out-of-band, risk-management system. Thus, a zero-latency risk-management system should not be considered to be dependent upon cancel-on-disconnect functionality.

### DESCRIPTION OF THE DRAWINGS

FIG. 1 illustrates an overview block diagram of a system for a zero-latency risk-management system according to an aspect of the invention;

FIG. 2a illustrates a block diagram of a system for a zero-latency risk-management system according to an aspect of the invention with a disabled kill-switch;

FIG. 2b illustrates a block diagram of a system for a zero-latency risk-management system according to an aspect of the invention with an enabled kill-switch;

FIGS. 3a-3d illustrate a block diagram of a system for a zero-latency risk-management system in operation according to an aspect of the invention;

FIGS. 4a-4b illustrate a block diagram of a system for a zero-latency risk-management system enabled to carry out in-line risk management functionality when the kill-switch is enabled;

FIG. 5a illustrates a flow diagram of a system for a zero-latency risk-management system according to an embodiment of the invention;

FIG. 5b illustrates a flow diagram of a system for a zero-latency risk-management system according to an aspect of the invention wherein the system user may be presented with the option to modify an order; and

FIG. 5c illustrates a flow diagram of a system for a zero-latency risk-management system according to an aspect of the invention wherein the system user may bypass an enabled kill-switch by modifying the order.

### DETAILED DESCRIPTION

Embodiments of the present invention will be described hereinbelow with reference to the accompanying drawings. In the following description, well-known functions or constructions are not described at length because they may tend to obscure the invention in unnecessary detail.

The present invention discloses a system and method for providing a zero-latency risk-management system that would useful to financial markets and futures contracts for tradable assets. For this application, the following terms and definitions shall apply:

The terms “communicate” and “communicating,” as used herein, refer to both transmitting, or otherwise conveying, data from a source to a destination and delivering data to a communications medium, system, channel, network, device, wire, cable, fiber, circuit, and/or link to be conveyed to a destination.

The term “computer,” as used herein, refers to a programmable device designed to sequentially and automatically carry out a sequence of arithmetic or logical operations, including without limitation, personal computers (e.g., those available from Gateway, Hewlett-Packard, IBM, Sony, Toshiba, Dell, Apple, Cisco, Sun, etc.), handheld processor-based devices, and any other electronic device equipped with a processor or microprocessor.

The term “database,” as used herein, refers to an organized body of related data, regardless of the manner in which the data or the organized body thereof is represented. For example, the organized body of related data may be stored to a storage device (e.g., a computer-readable medium, such as, for example, a hard drive, flash memory, etc.) in the form of one or more of a table, map, grid, packet, datagram, frame, file, e-mail, message, document, report, list, or in any other form.

The terms “exchange” and “market center,” as used herein, refer to an organized market where, for example, tradable securities, commodities, foreign exchange, futures, and options contracts may be bought and/or sold and may include, but are not limited to, the New York Stock Exchange (NYSE); New York Mercantile Exchange (NYMEX); NASDAQ Stock Market (NASDAQ, formerly known as the “National Association of Securities Dealers Automated Quotations”); the Chicago Mercantile Exchange (CME); U.S. Futures Exchange; Tokyo Stock Exchange; Tokyo Commodity Exchange; London Stock Exchange; Shanghai Stock Exchange; Hong Kong Stock Exchange; Toronto Stock Exchange; Bombay Stock Exchange; National Stock Exchange of India; BM&F Bovespa; Australian Securities Exchange; Deutsche Borse; Shenzhen Stock Exchange; SIX Swiss Exchange; BME Spanish Exchanges; Korea Exchange; MICEX; and JSE Limited.

The term “network,” as used herein, refers to networks and inter-networks of all kinds, including the Internet, but is not limited to any particular network or inter-network.

The term “processor,” as used herein, refers to processing devices, apparatus, programs, circuits, components, systems and subsystems, whether implemented in hardware, tangibly embodied software or both, and whether or not programmable. The term “processor,” as used herein includes, but is not limited to, one or more computers, hardwired circuits, signal modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, and data processors.

The terms “order” and “order contract,” as used herein, refer to an instruction, written or oral, from a first party (e.g., a customer) to a second party (e.g., a trading firm or a broker) to buy or sell stock or a financial instrument, commodity, or the like on an exchange or other financial marketplace and may include, but is not limited to, market orders; limit orders; day orders; good-till-cancelled orders; immediate-or-cancel orders; fill-or-kill orders; conditional orders, such as, for instance, stop orders, peg orders, market-if-touched orders, one-cancels-other orders, and tick-sensitive orders; and discretionary orders. While the first and second parties are often separate persons or entities, when applied to proprietary trading, the first party and second party may be the same person or entity. The order may specify certain parameters combined with price instructions for the order including, for example, the number of shares and price range.

For a filtered-access system, a trading firm typically sends the order to the sponsoring firm after the order is generated, and the sponsoring firm handles the risk-management system and gateways. The filtered-access system has a number of disadvantages. First, the sponsoring firm's gateway technology is often slower than that of the trading firm. Second, the additional communication from the trading firm's network to the sponsoring firm's network introduces network latency. Third, the trading firm has reduced control over the development of the gateways and is thus unable to quickly implement new features (e.g., new exchange order types or new protocols); it also has a reduced ability to diagnose problems. Finally, the trading firm may be required to translate orders into the sponsoring firm's preferred order routing protocol, thereby introducing protocol latency. These various drawbacks combine to introduce a significant amount of delay and limited control to the trading firm.

For a direct-access system, a trading firm accesses an exchange directly and is able to clear its own transactions. This is typically accomplished by using a pretrade, risk-management system situated between the system components that generate, receive, and/or input orders (e.g., strategies or manual orders) and the components (e.g., gateways) that ultimately transmit an order to an exchange or a market center. The gateways are typically the last programmable components that touch an order before it is sent through networking hardware into the market center's network.

An exemplary risk-management system and method is taught by U.S. Patent Publication No. 2010/0223201 to Callaway et al., entitled “OUT OF BAND CREDIT CONTROL” (“Callaway”). Callaway teaches a system and method for mediating risks associated with orders in an electronic trading system. A front-end component includes a plurality of trading engines that receive orders from traders. A back-end component includes a match system. The system further includes a credit-control module to monitor aggregate risk parameters for the trading engines and requests credits from trading engines.

To address difficulties in the above-mentioned systems, the present invention provides a zero-latency risk-management system that may be applied to any trading system, including, for example, sponsored access and in-house for direct-access situations. The present disclosure differs from the Callaway system in that it permits zero-latency risk management, a crucial factor in the trading industry. Zero latency can be accomplished by observing and evaluating risk data in parallel (as opposed to in-line) with order routing while enforcing risk controls in-line (e.g., using a kill-switch).

Contrary to the present disclosure, Calloway teaches a fully in-line, risk-evaluation system that yields unnecessary latency. For example, Calloway teaches a matching system to receive derivative-product-order risk data, including at least one threshold value corresponding to at least one order risk parameter. In operation, the match system receives an order for a derivative product from a trader. The match system uses the derivative-product order and a trader's current order-risk-utilization state to calculate utilization data. The derivative-product order is processed in a manner determined by the derivative-product-order risk data and the utilization data. If the execution of the trade did not cause the resulting utilization data to exceed the relevant utilization threshold, the trade would be executed. As evidenced by the trade not being placed into the trade match module until provided acceptance from the credit control module, the Calloway system must analyze received orders prior to communicating the orders to market centers. This analysis step, regardless of speed, will still yield a degree of latency, which, even if on the microsecond level, can be considered unduly latent and therefore yield additional unwanted risk. Calloway attempts to remedy this delay by providing extensions to the limited in-line processing. Calloway discusses out-of-band processing, but it cannot guarantee enforcement in-line. Although Calloway discusses out-of-band, near real-time processing, the controls still filter through the credit module to check and approve/disapprove the order in-line.

Contrary to Calloway, the present disclosure yields real-time processing with a guarantee of zero latency. In its simplest form, the present system comprises an “out-of-band,” risk-monitoring computer and a kill-switch. The out-of-band, risk-monitoring computer monitors each order, in parallel (as opposed to in-line), as it flows through the system and updates any risk metrics based on that order. Threshold levels are set in the risk-monitoring computer to a desired level of risk, minus the maximum amount of risk that a subsequent new order could incur (e.g., the risk limit minus N−N being the maximum possible risk that a subsequent new order). If the risk monitor determines that the order has breached this “minus N” threshold, the kill-switch is triggered to prevent the entry of additional orders that may breach the actual threshold.

As used herein, a kill-switch may be any device, apparatus, method, or the like capable of preventing an order from being communicated to, or executed in, a market center or exchange. The kill-switch may be, for instance, a true kill-switch (physical or software-implemented) on a network enabled to trigger a gateway cancel-on-disconnect; however, other variations exist. For example, some exchanges permit blocking transactions in individual tickers (akin to removing a locate flag) that may permit refined control. For instance, once an alert is triggered, a network device may drop (e.g., terminate) packets selectively based on a filter, thereby only dropping orders for a single ticker. While this arrangement may add latency, it is typically faster than a system or method where no alert has been triggered. Alternatively, once an alert is triggered, a network device may reroute packets to a traditional in-line system in order to permit more granular or sophisticated filtering. Such an arrangement would not introduce any additional latency since a network device enabled to perform network routing is typically already present in a system that trades electronically over a network. Alternately, refined controls could be implemented by restricting a set of gateways to particular tickers or market sectors, thus limiting the negative impact of triggering the kill-switch.

While the following examples focus on an aspect where a kill-switch is inserted between the system components that generate, receive, and/or input orders and a gateway that sends an order through a firm's networking hardware to an exchange or a market center's network, other arrangements are possible. For example, the kill-switch may be inserted between the gateway and a market center, or at any other location between the system components and the market center, thereby enabling order-termination prior to, or upon receipt by, the marketplace. According to this aspect, the market center may, for example, implement the kill-switch functionality (e.g., terminate the order) based on a signal (e.g., a termination signal) from the risk management system. A termination signal, as used herein, refers to any signal or command that may be communicated to a market center to trigger the termination of one or more orders (e.g., a command to disable all trading for MPID ABC or firm XYZ, or login DEF; or to disable SPY for MPID ABC or firm XYZ or login DEF, etc.). Regardless of the location of the kill-switch, the essential operations and algorithms of the out-of-band, risk-monitoring system could remain substantially the same. The primary differences would be the method of, or system for, terminating the order (e.g., disconnect, notifying market center such that they reject a certain order, etc.).

For example, assume that the maximum open orders limit for the S&P 500 ETF “SPY” is set to 10,000,000 shares, and the maximum order size is 100,000 shares. If there are orders outstanding for 9,700,000 shares and an order to buy 100,000 shares is sent, the risk management component will update its current counter to 9,800,000. If the next order sent is for 100,000 shares, the total outstanding would be 9,900,000. Since the next order could breach the limit (assuming a maximum order size), the kill-switch is enabled to prevent additional order placement.

There are a number of suitable and useful variations on this concept. For example, the maximum amount of risk an order can incur may be limited by either the order entry protocol itself or risk controls implemented at the exchange. For example, many exchanges permit setting a maximum order size, sometimes on a per-ticker basis. As a kill-switch may be viewed as a dramatic measure, one or more warning thresholds may be set below the kill threshold level to caution the system user (e.g., a buyer, customer, trading firm, broker, or computer operating on behalf of the user of the system). Although the “kill-switch,” cancel-on-disconnect approach may seem extreme, with an accurate computation of current risk levels and prior warning, the risk of false positive triggers would be nearly eliminated, such that the benefit of the system would greatly outweigh any impairment.

The risk control component may be configured to avoid implementing simple checks (e.g., total outstanding SPY size), but instead applying more intelligent checks (e.g., weighted outstanding SPY size net of all S&P exposure). Such checks may include overall firm notional exposure, sophisticated value-at-risk computations, or scaling the risk associated with certain orders based on historical data regarding the probability of execution. For example, in the example provided in paragraph [0045], the total outstanding value of orders for the S&P 500 ETF “SPY” is 9,900,000, but if the firm had a short position in S&P futures equivalent to short exposure of 2,000,000 SPY shares, the outstanding exposure for computational purposes might be reduced to 7,900,000.

The system may also permit exchange integration to receive a real-time stream of throttle/threshold parameters from one or more clearing films. Exchange-implemented controls are currently based on relatively static configurations, and thus are generally inflexible. Fundamentally, exchange-implemented controls cannot be adjusted for activity occurring in real-time elsewhere (e.g., third parties), whether risk reducing or risk increasing. Therefore, integrating a real-time stream would permit more accurate risk controls at the exchange by using the available clearing firm information while avoiding the latency of a traditional filtered solution.

The system may also permit an exchange to implement a third-party throttle by permitting the third party to implement custom throttles defined via a programming language. This arrangement enables a clearing firm to run software code on the exchange gateways of the clearing firm clients, thus eliminating the network hop in traditional filtered access but retaining the ability to define customized risk controls.

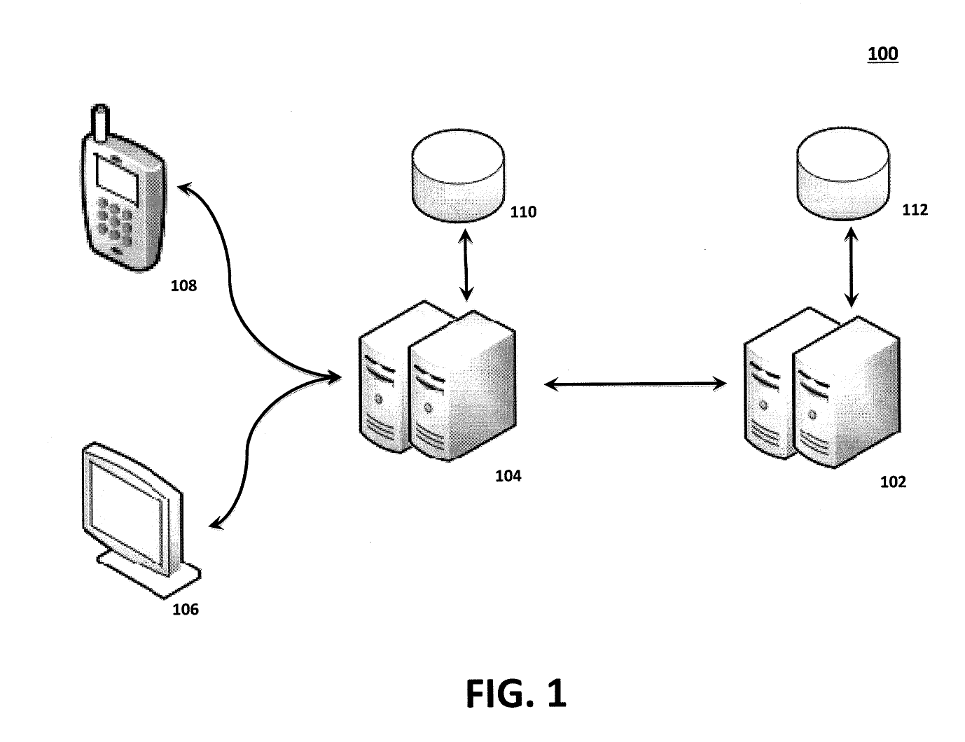

Referring to FIG. 1, a block diagram illustrates an electronic trading system 100 according to a preferred embodiment of the present invention. The system includes one or more servers 102, also referred to as market or trading hosts 102, and one or more interfaces 104 also referred to as trading firms 104. The trading host 102 is preferably implemented by the use of one or more general purpose computers, such as, for example, a Sun Microsystems F15k. Each interface 104 is also preferably implemented by the use of one or more general purpose computers 106, such as, for example, a typical personal computer manufactured by Dell, Gateway, Hewlett-Packard, Apple, and/or one or more portable devices 108, such as, for example, a smart phone manufactured by RIM, HTC, Motorola, Nokia, or Apple. Each of the trading host 102 and the interface 104 may include one or more microprocessors. The microprocessor can be any type of processor, such as, for example, any type of general-purpose microprocessor or microcontroller, digital-signal processing (“DSP”) processor, application-specific integrated circuit (“ASIC”), programmable read-only memory (“PROM”), or any combination thereof The interface 104 may use its microprocessor to read a computer-readable medium containing software that includes instructions for carrying out one or more of the functions of the interface 104, as further described below.

Each of the trading host 102 and the interface 104 can also include computer memory, such as, for example, random-access memory (“RAM”). However, the computer memory of each of the trading host 102 and the interface 104 can be any type of computer memory or any other type of electronic storage medium that is located either internally or externally to the trading host 102 or the interface 104, such as, for example, read-only memory (“ROM”), compact disc read-only memory (“CDROM”), electro-optical memory, magneto-optical memory, erasable programmable read-only memory (“EPROM”), electrically-erasable, programmable, read-only memory (“EEPROM”), or the like. According to exemplary embodiments, the respective RAM can contain, for example, the operating program for either the trading host 102 or the interface 104. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the trading host 102 and the interface 104 can also include a database 110, 112. The database 110, 112 can be any type of computer database for storing, maintaining, and allowing access to electronic information stored therein. For instance, database 110 may be used to store derivative product order formulas. The formulas may be provided by traders or may be standard formulas provided by an exchange. The host server 102 preferably resides on a network, such as a local area network (“LAN”), a wide area network (“WAN”), or the Internet. The interface 104 preferably is connected to the network on which the host server resides, thus enabling electronic communications between the trading host 102 and the interface 104 over a communications connection, whether locally or remotely, such as, for example, an Ethernet connection, an RS-232 connection, the Internet, or the like.

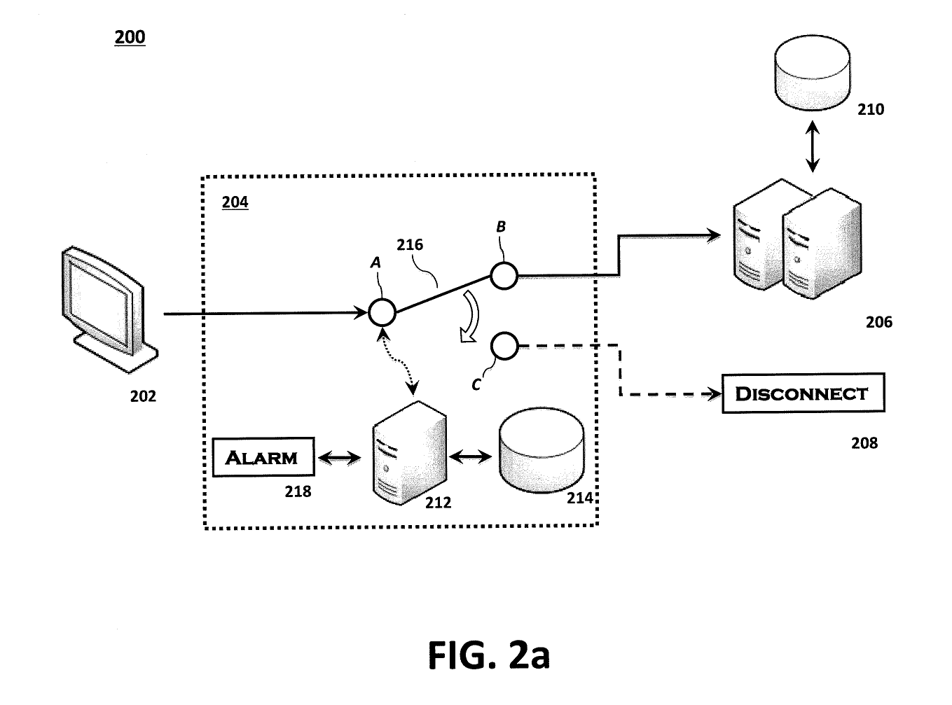

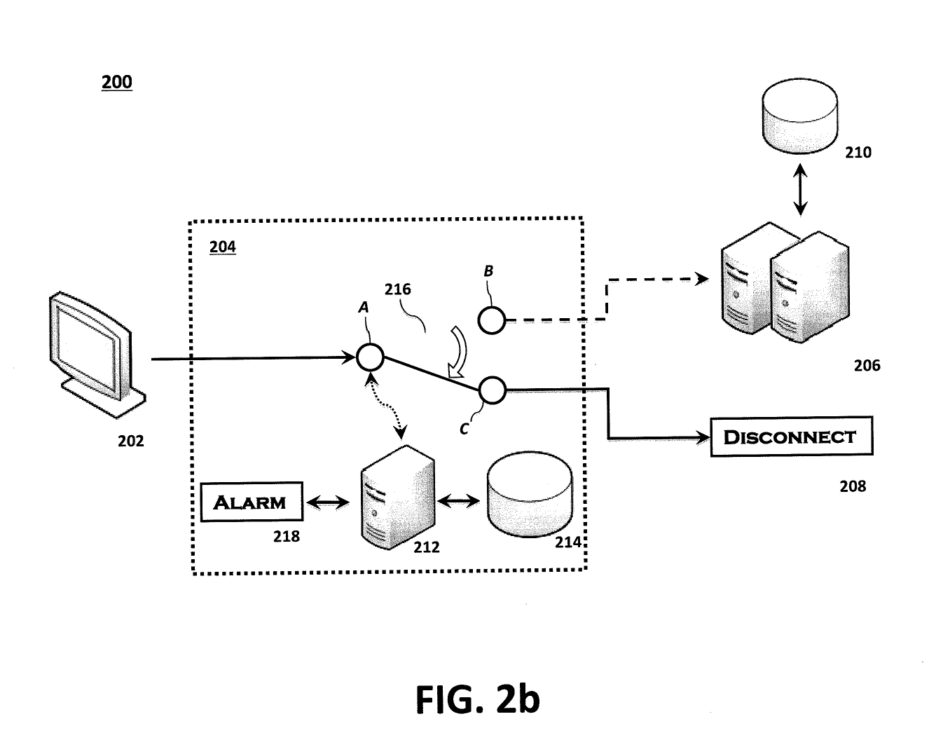

FIGS. 2a and 2b illustrate a system 200 exemplifying an embodiment of the present invention. In essence, a primary objective of a trading firm is to instantly communicate an order from system components 202 that generate, receive, and/or input orders to the gateways 206, while also applying risk management protocols. The gateways 206 are typically the last programmable components to touch an order before it is sent through a firm's networking hardware to an exchange or a market center's network. As previously discussed, typical risk management protocols usually delay an order because they are in-line with the system and require that certain criteria be met prior to forwarding the order to the gateways 206. The present system 200 discloses a zero-latency risk-management system 204 positioned in parallel with the path between the system components 202 and the gateways 206 capable of terminating an order without introducing latency inherent to in-line systems. Unlike an in-line system, the zero-latency risk-management system 204 does not act as a filter along a path between system components 202 and gateways 206 requiring order analysis before forwarding an order to the gateways 206, but instead monitors orders and allows them to pass uninterrupted until a preset kill-switch threshold is met. The zero-latency risk-management system 204 generally comprises a kill-switch 216, a risk-monitoring computer 212, and a computer-readable medium 214. The risk-monitoring computer 212 may use a microprocessor to read a computer-readable medium 214 containing data and software that includes instructions for carrying out one or more of the functions of the risk-monitoring computer 212. The risk-monitoring computer 212 can be used to monitor the orders in real time while tracking and calculating the various parameters and updating the risk value as each order is reviewed. For example, a risk-monitoring computer 212 may be an out-of-band risk monitor enabled to watch each order as it travels through the system and to update any risk metrics based on that order. As depicted in FIG. 2b, once an order parameter meets or exceeds a certain preset kill-switch threshold, the risk-monitoring computer 212 enables the kill-switch 216 (e.g., disconnecting the connection between-kill-switch 216 nodes A and B), thus canceling subsequent orders upon disconnect. Kill-switch threshold levels may be set in the risk monitoring computer to a desired level of risk, minus the maximum amount of risk that a subsequent new order could incur. Although FIGS. 2a and 2b depict a disconnect 208 module connected to kill-switch 216 at node C, node C need not be connected to anything, but rather, an enabled kill-switch may simply be an open switch without node C. Similarly, upon triggering a disconnect 208, the risk-monitoring computer 212 may cause alarm 218 to be triggered. The alarm 218 may be, for example, an audible sound, message, e-mail, text, or other signal to the system user that the kill-switch threshold has been met or exceeded. The alarm 218 may also be used to notify the system user that a preset warning threshold has been met or exceeded. As exemplified in FIGS. 2a and 2b, the risk-monitoring computer 212 and computer-readable medium 214 are out-of-band (e.g., not in-line with the system 200, but parallel therewith) but are enabled to enable/disable the in-line kill-switch 216, a configuration that introduces zero latency into the system. While the in-line kill-switch 216 has been placed between the system components 202 and gateways 206, one having ordinary skill in the art would appreciated that the kill-switch 216 may be placed at virtually any point between the components 202 and an exchange or a market center's network. Similarly, risk-management system 204 may be configured to communicate a termination signal to the exchange or a market center once an order parameter meets or exceeds a certain preset threshold instructing the exchange or a market to reject or automatically terminate one or more orders (e.g., a command to disable all trading for MPID ABC or firm XYZ or login DEF; or to disable SPY for MPID ABC or firm XYZ or login DEF, etc.).

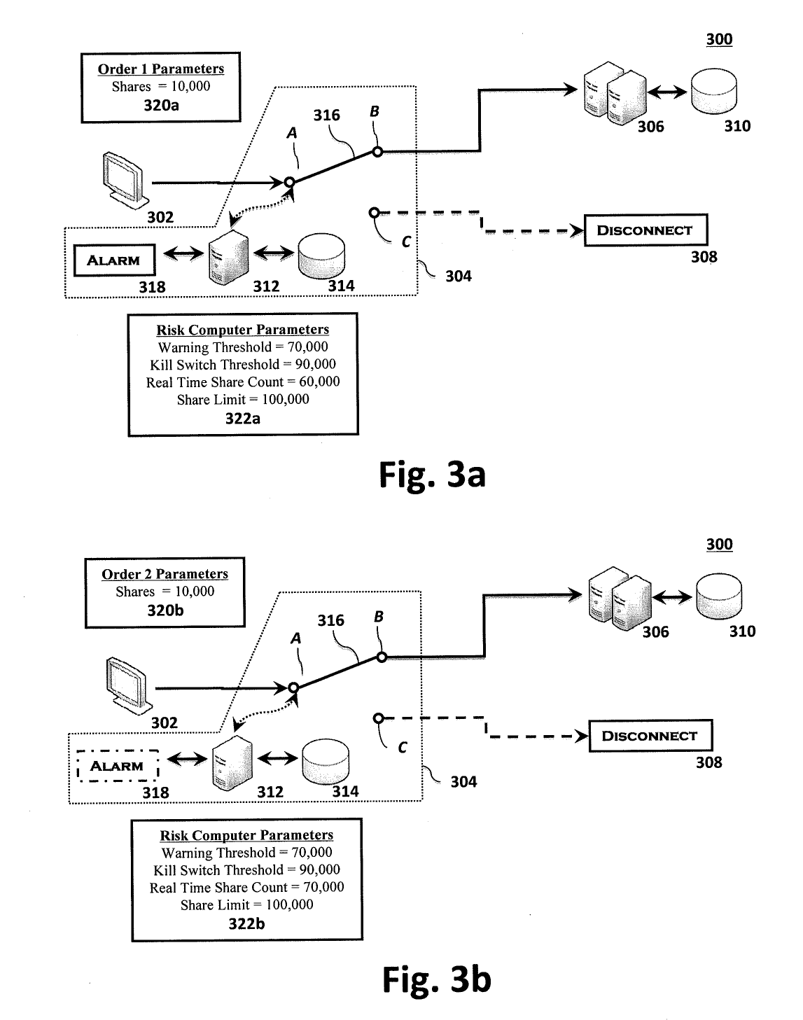

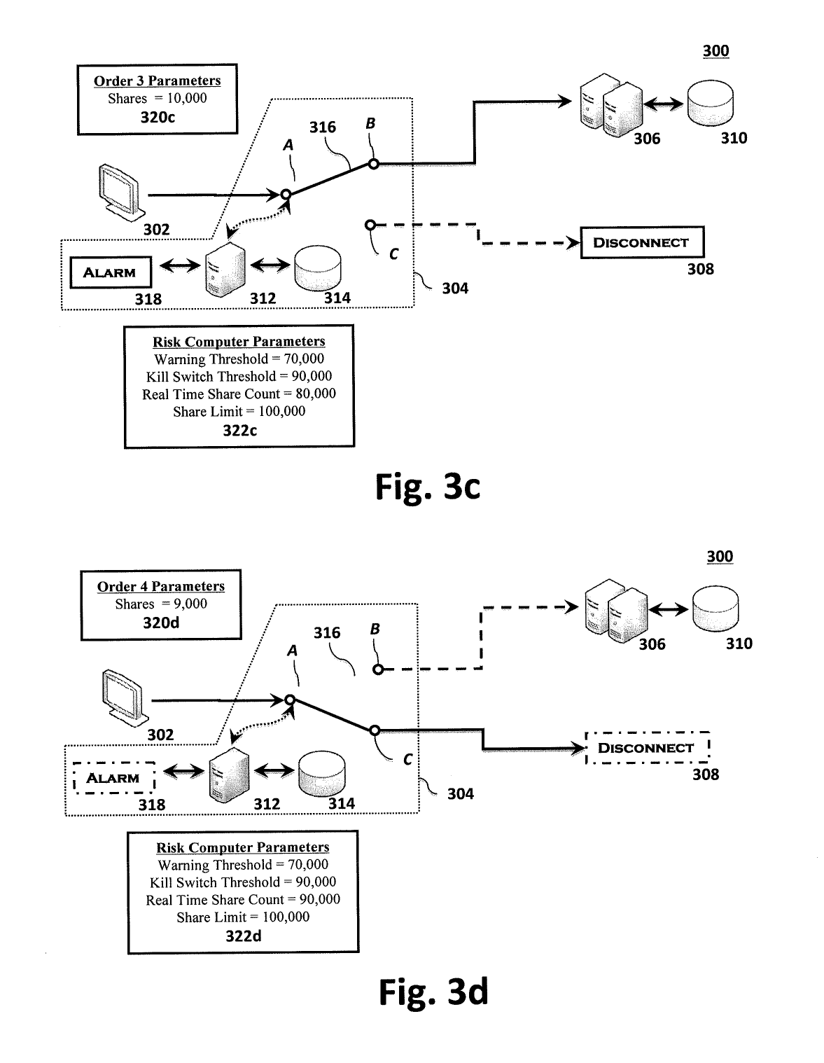

FIGS. 3a through 3d illustrate a system 300 exemplifying an embodiment of the present invention in operation. As in FIGS. 2a and 2b, the system 300 comprises system components 302 to generate, receive, and/or input orders, gateways 306, and a risk-management system 304 generally comprising a kill-switch 316, a risk-monitoring computer 312, and a computer-readable medium 314. For this example, assume that the maximum open order limit for Stock A is set to 100,000 shares (“share limit”), and the maximum order size is 10,000 shares (“order limit”). To enforce the maximum order limit, the risk-management system 304 may be set to automatically reject any order exceeding a preset share limit. The risk-management system 304 may further notify the system user of the rejection and optionally prompt the system user to adjust the share value to comply with the maximum order limit. The risk-management system 304 may be set to recognize one or more risk computer parameters 322 and take these values into consideration. For example, in FIG. 3a, prior to the execution of Order 1, risk computer parameters 322a reflect a real-time share count of 60,000 shares, a share limit of 100,000 shares, and a kill-switch threshold set to 90,000 shares on the basis that the following trade is 10,000 shares (the maximum order limit for Stock A) and would breach the share limit of 100,000. The risk-computer parameters 322a are updated in real time and track, for example, the current, real-time share count, which, in FIG. 3a, equals 60,000 prior to execution of Order 1. A warning threshold may also be set as a risk-computer parameter 322a to indicate to the system user that the current real-time share count is nearing the kill-switch threshold, thereby allowing the system user to respond accordingly (e.g., reduce subsequent order share sizes or a push priority order to the front of the queue). For the purpose of this example, the warning threshold has been set to 70,000 shares indicating to the system user that only two additional orders of 10,000 shares (maximum share amount) may be executed before the kill-switch is enabled. Although only one warning indicator is used in the example, a person having ordinary skill in the art would appreciate that multiple warning indicators may be used, thereby giving the system user various levels of advance warning.

Referring now to FIG. 3b, Order 1 has successfully been communicated to the gateways 306, and the risk-computer parameters 322b have been updated in real time and now indicate a real-time share count of 70,000 (the previous share count plus Order 1's shares). However, because the current share count is 70,000 shares and the warning threshold is 70,000 shares, alarm 318 is triggered to indicate to the system user that a certain parameter is elevated. Although the warning threshold is triggered, Order 2 is not delayed or prohibited from being sent to the gateways 306 for entry into an exchange.

Referring now to FIG. 3c, Order 2 has successfully been communicated to the gateways 306, and the risk computer parameters 322c have been updated in real time and now indicate a real-time share count of 80,000 (the previous share count plus Order 2's shares). Because the kill-switch threshold (90,000 shares) has not yet been reached, the kill-switch 316 has not been triggered (i.e., remains disabled), and therefore orders are still permitted. As with Order 1 and. Order 2, Order 3 is not delayed or prohibited from being sent to the gateways 306 for entry into an exchange.

Referring now to FIG. 3d, Order 3 has successfully been communicated to the gateways 306, and the risk computer parameters 322d have been updated in real time and now indicate a real-time share count of 90,000 (the previous share count plus Order 3's shares). However, because the current share count is 90,000 shares and the kill-switch threshold is 90,000 shares, kill-switch 316 and alarm 318 are triggered to indicate to the system user that a certain parameter has met or exceeded the kill-switch threshold.

Because the kill-switch threshold was triggered (i.e., enabled) by Order 3 and not enabled prior to submission of Order 3, Order 3 is not delayed or prohibited from being sent to the gateways 306 for entry into an exchange. As seen in FIG. 3d, once Order 3 has been communicated to the gateway 306, kill-switch 316 nodes A and B are no longer connected; rather, nodes A and C are now connected to trigger a gateway cancel-on-disconnect. Now that the kill-switch threshold is triggered, Order 4 and subsequent orders are prohibited from being sent to the gateways 306 for entry into an exchange. Although FIGS. 3a through 3d depict a disconnect 308 module connected to kill-switch 316 at node C, node C need not be connected to anything; rather, an enabled kill-switch may simply be an open switch without node C.

In certain embodiments, in-line risk-management system functionality may be integrated with the risk-management system of FIGS. 3a through 3d. As in FIGS. 3a through 3d, the system 400 comprises system components 402 to generate, receive, and/or input orders; gateways 406, and a risk-management system 404 generally comprising a kill-switch 416, a risk monitoring computer 412, and a computer-readable medium 414. However, unlike the earlier examples, the system 400 further comprises a secondary connection 418, or other means for bypassing the kill-switch 416, for communicating orders to gateways 406 for entry into an exchange. Once the kill-switch threshold has been breached and the kill-switch 416 has been enabled, the risk-management system 404 may use the secondary connection 418 and function as an in-line risk-management system to filter any remaining outstanding orders. In this situation, the risk-management system 404 may be configured to perform calculations to allow orders that would not violate or exceed a known parameter (e.g., share limit). For example, after the kill-switch threshold has been breached and the kill-switch 416 has been enabled, a risk-management system 404, acting as an in-line risk-management system, may calculate the difference between the real-time share count and the share limit, compare the difference to one or more orders in queue, and permit an order containing fewer shares than the calculated difference to be forwarded to the gateways 406 for entry into an exchange via second connection 418 until one of the following occurs: (i) the share limit has been met; (ii) no orders remain; or (iii) no orders equal to or less than the real-time calculated difference remain. Under this arrangement, all orders received prior to enabling of the kill-switch 416 would encounter zero-latency, and any orders in queue after enabling of the kill-switch 416 would not be automatically prohibited from entering the market; rather, remaining orders could be managed using an in-line risk-management system.

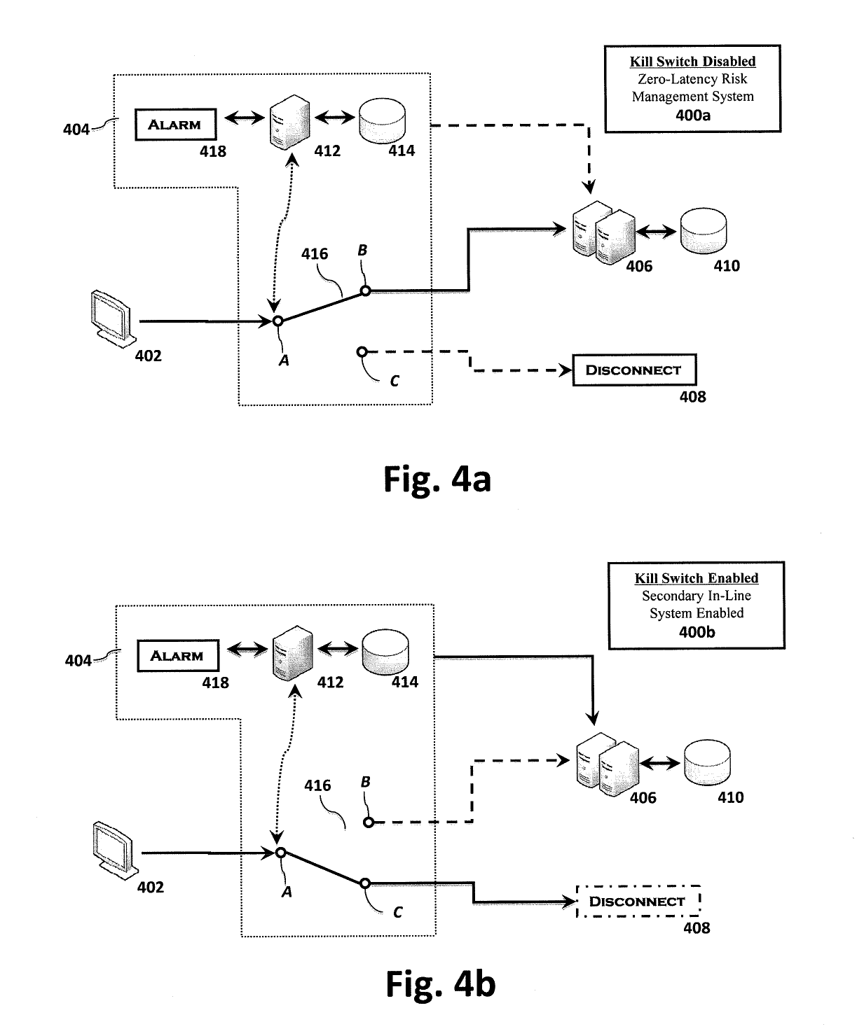

Building on the previous example and applying in-line risk-management functionality as depicted in FIG. 4b, Order 4 would not be automatically prohibited from being sent to the gateways 406 for entry into an exchange because Order 4's 9,000 shares are less than 10,000 (the difference between the real-time share count and the share limit, 100,000−90,000=10,000). If, for instance, subsequent Order 5 were an order greater than 1,000 shares, the risk-management system 400 would use in-line, risk-management functionality to prohibit Order 5 from being sent to gateways 406 for entry into an exchange via the second connection 418 because the order would cause the real-time share count to exceed the share limit. In this situation, the risk-management system 400 may skip Order 5 and determine whether the next Order (e.g., Order 6) is less than or equal to 1,000 shares so that it may be sent to gateways 406 for entry into an exchange via the second connection 418. This process may continue until one of the following occurs: (i) the share limit has been met; (ii) no orders remain; or (iii) no orders equal to or less than the real-time calculated difference remain.

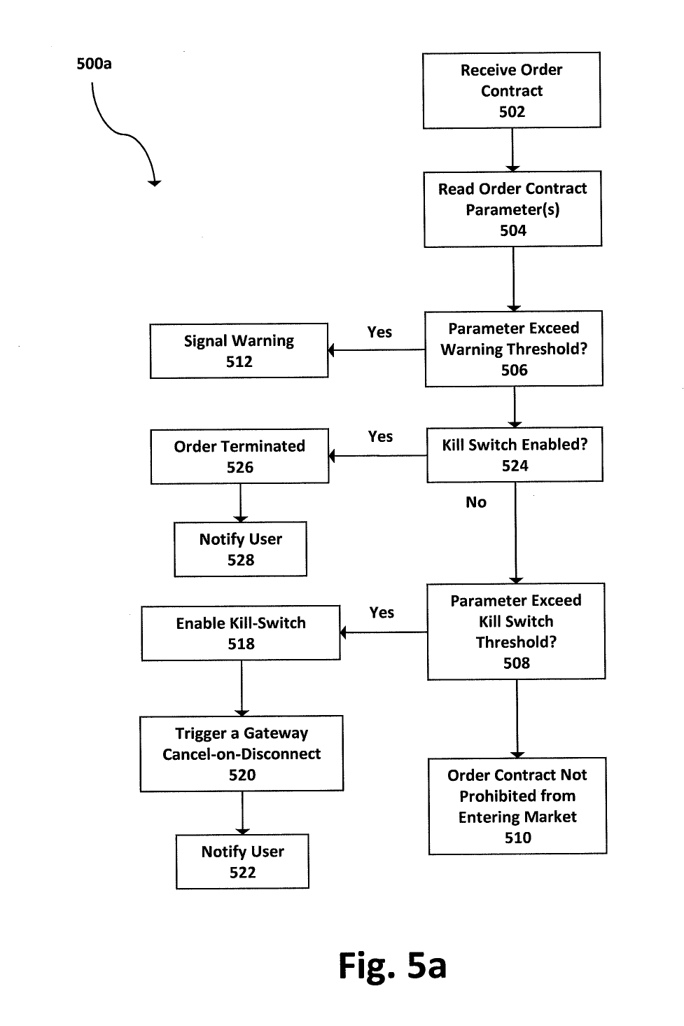

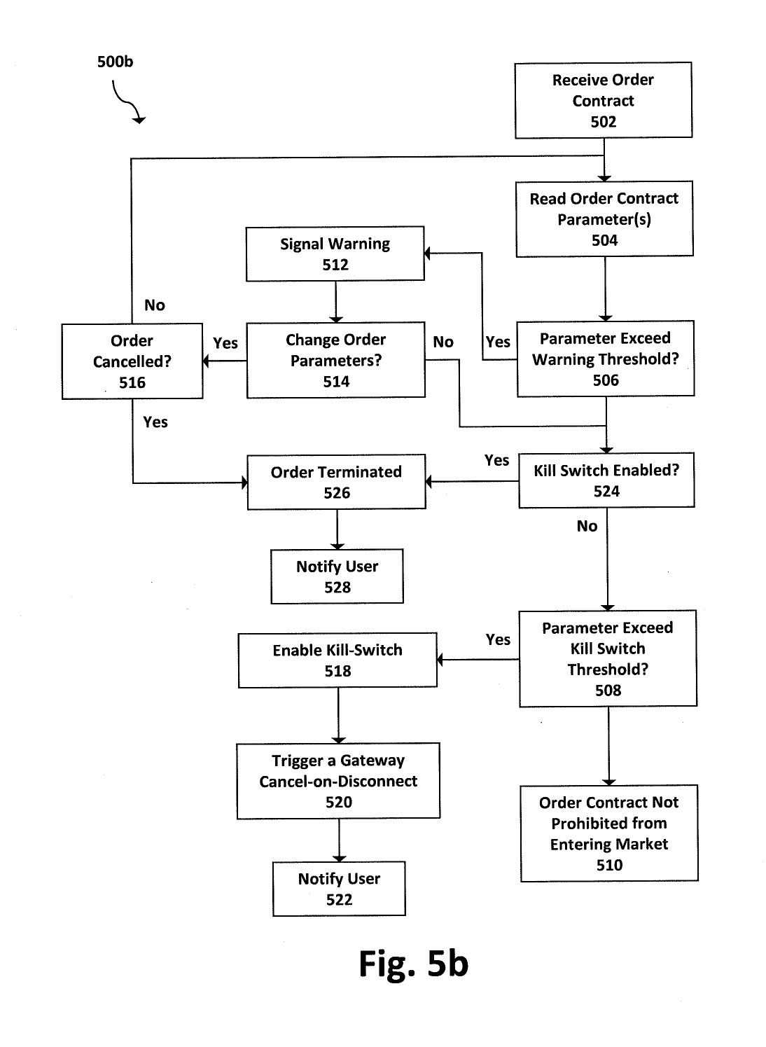

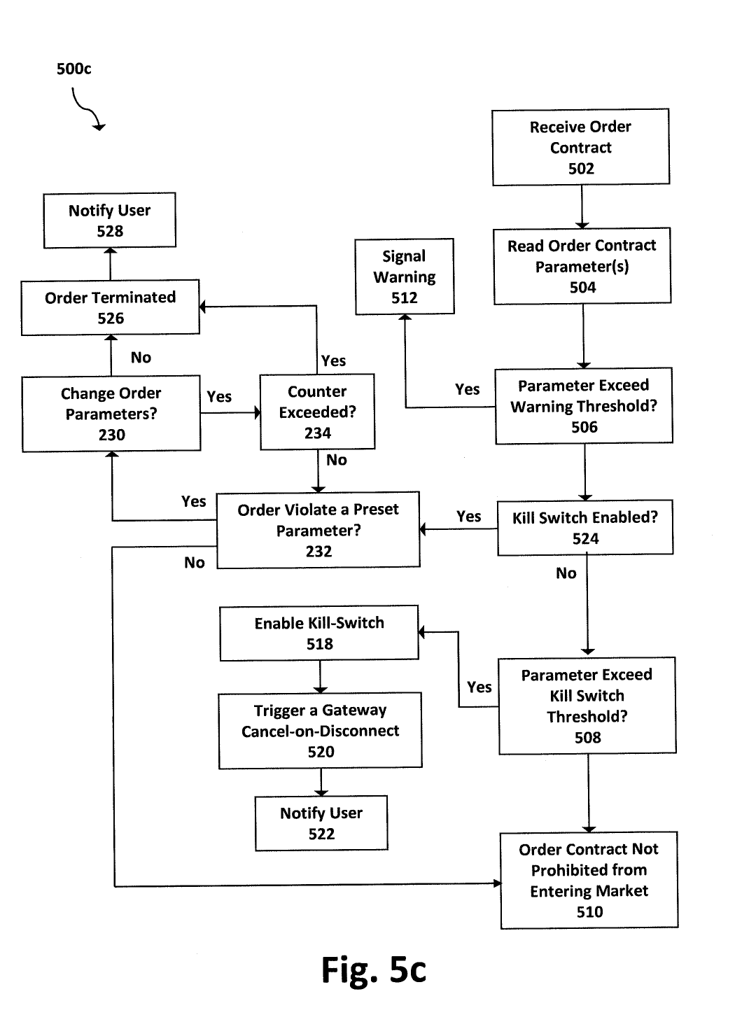

Referring to FIG. 5a, a flowchart 500a illustrates a process that may be executed by the system 100 for facilitating a zero-latency risk-management system and method, according to a preferred embodiment of the present invention.

In the first step 502, an order for a first contract involving a tradable asset is received by the system or generated by a trading-firm computer. The order may include a number of parameters, including, for example, stock or commodity identification, number of shares, and maximum share price, side (buy or sell), time-in-force, order capacity (e.g. principal or agent), an identifier unique to the firm, an identifier unique to the order, or any exchange-specific special flags (e.g. pegging, hidden or displayed, etc). At step 504, the system computer reads the various parameters and compares one or more parameters to preset threshold values stored in memory. At step 506, the system determines whether one or parameters have met or exceeded a preset warning threshold value. The system may include multiple warning thresholds to indicate to the system user (e.g., a buyer, customer, trader, trading firm, broker, or computer operating on behalf of the user of the system) that a certain parameter is elevated. If the system computer has found that a parameter has met or exceeded a preset warning threshold value, the system computer may generate a warning signal at step 512. The warning signal may be communicated to one or more system users using, for example, a computer, smart phone, or other portable electronic device. The warning signal may be in the form of, for example, an audible sound, message, e-mail, text or other signal to the system user that a threshold has been met or exceeded. Although a warning signal may be generated, the order triggering the warning signal would be unaffected by the warning and would not be delayed or prohibited from proceeding to step 524.

At step 524, the system computer determines whether the kill-switch has been previously enabled (e.g., by a previous order); thereby triggering a gateway cancel-on-disconnect. If the kill-switch has been previously enabled, the order is unable to proceed and is therefore terminated at step 526. The system user may be notified of the termination at step 528 by, for example, an audible sound, message, e-mail, text or other signal to the system user that a threshold has been met or exceeded. However, if the kill-switch has not been previously enabled (i.e., the switch remains disabled), the order would be unaffected and would not be delayed or prohibited from proceeding to step 508.

At step 508, the system computer may read the order parameters and compare one or more parameters to a preset kill-switch threshold value stored in memory. If a preset kill-switch threshold has been met, a kill-switch would be enabled at step 518. Enabling the kill-switch at step 518 triggers a gateway cancel-on-disconnect at step 520 and optionally notifies a system user at step 522 of the gateway cancel-on-disconnect. A gateway cancel-on-disconnect 520 prohibits future orders from being communicated to the market or exchange. Although a kill-switch enable signal is generated, the order triggering the kill-switch threshold would be unaffected by the kill-switch enabled signal and would not be delayed or prohibited from proceeding to the exchange or market at step 510.

Referring now to FIG. 5b, in another embodiment, upon signaling the warning at step 512, the system user may be presented with the option to change one or more order parameters (e.g., increasing/decreasing the number of shares) at step 514. At step 516, if the system user opts to change a parameter, the system user may be further presented with the option to cancel the order. If the system user opts to cancel the order, the order would be terminated at step 526 and the system user may be notified with a confirmation message at step 528. However, if the system user does not opt to cancel the order but has merely made a change to the order, the order may be returned to step 504. Each of these decisions and/or modification may be automatically implemented using computer-implemented software and/or methods using predetermined software, algorithms, settings, threshold and the like. However, to avoid introducing any latency, in a preferred embodiment, the system computer may be configured to prevent delaying the order from proceeding to step 524, such that the order triggering the warning threshold will be unaffected by the warning and is not delayed from being communicated to step 524.

Referring now to FIG. 5c, in yet another embodiment, if a kill-switch is enabled at step 524, the order may be reviewed using pre-trade, risk-control management protocols at step 532 to determine if the current order violates a preset parameter. If the system computer determines that that the current order does not violate a preset parameter at step 532, the order may bypass the kill-switch and proceed down the line to the exchange or market at step 510. However, if the system computer determines that the order violates a preset parameter at step 532, the system user may be presented with the option to change one or more order parameters (e.g., increasing/decreasing the number of shares) at step 530 in an attempt to make the order compliant with the preset parameters. This feature may be useful in the event that the full order (e.g., maximum share order) would exceed the share limit, but a reduced number of shares would comply with the required parameters.

If the system user does not opt to change a parameter (e.g., directly or by failure to act), the order will be terminated at step 526 and the system user may be notified at step 528. However, if the system user changes the order at step 530, the order may be reevaluated using risk-control management protocols at step 532 to determine if the order violates a preset parameter. If the order still violates a parameter, the system user may be permitted a second opportunity to change an order parameter at step 530. This procedure may be repeated until a system computer determines that the system user has either (i) exceeded the permitted number of order modifications at step 534 or (ii) the order is compliant with the preset parameters. For example, a counter may be enabled at step 534 such that a system user is only able to modify an order parameter three times and if the system user attempts to change the order for a fourth time, the order will be automatically terminated at 526. Each of these decisions and/or modification may be automatically implemented using computer-implemented software and/or methods using predetermined software, algorithms, settings, threshold, and the like.

A notable feature of the systems 500a, 500b, 500c of FIGS. 5a through 5c is that all of these actions and checks prior to enablement of the kill-switch occur without impacting or delaying the order, therefore yielding a zero-latency risk-management system. An order may only be impacted or delayed if the order is either (i) modified by the system user or (ii) the kill-switch has been enabled, otherwise; the order would merely travel down the line to the exchange or market.

The zero-latency risk management system of the present invention may be used, alone or in combination with other risk management systems, to satisfy SEC requirements, including, for example, SEC 240.15c3-5.1.ii that requires prevention of erroneous orders that exceed “appropriate price or size parameters.” To satisfy SEC 240.15c3-5.1.ii, exchange system functionality may be integrated with the zero-latency risk-management system to achieve full compliance while benefiting from the zero-latency portion, permitting the exchange to execute price reasonableness tests based on exchange market data, and the firm to execute firm-wide financial risk management tests based on the firm's specific position and order data, which may incorporate activity on multiple exchanges. For example, NASDAQ offers an example of suitable exchange functionality called Pre-Trade Risk Management (PRM). NASDAQ's PRM “fat finger” price-checks reject an order if it deviates more than an order book configured parameter (%), pre-set by the exchange with a reject message (e.g., “bad price”) before it may execute with “virtually no latency.” This configuration would still yield less latency than any filtered solution.

In certain embodiments, the zero-latency risk-management system of the present invention may integrate contingent order functionality. In its most general form, a contingent order is an advanced type of order that can be placed beforehand, and would only be executed once one or more preset conditions are met (or not met). For example, assume a client wishes to purchase 5,000 shares of Stock A, but would purchase 7,000 shares of Stock B if Stock A violated a certain parameter or was otherwise unavailable (e.g., share limit was met). Under this system, if Stock A is processed using the zero-latency risk-management system but the kill-switch has already been enabled, then the order for 7,000 shares of Stock B may be automatically processed using, for example, zero-latency risk-management functionality or a secondary in-line system. This arrangement permits a trader to choose secondary back-up stocks and/or commodities in the event a first stock or commodity fails to be executed.

The zero-latency risk-management system of the present invention may also meet the necessary regulatory requirements of certain overseas markets, such as the Tokyo Stock Exchange. Although various embodiments have been described with reference to a particular arrangement of parts, features, and the like, these are not intended to exhaust all possible arrangements or features, and indeed many other embodiments, modifications, and variations will be ascertainable to those of skill in the art.

All U.S. and foreign patent documents, and all articles, brochures, and all other published documents discussed above are hereby incorporated by reference into the Detailed Description.

What is claimed is:

1. A system for providing zero latency risk monitoring comprising:
(i) a component for receiving or generating an order;
(ii) a gateway for communicating an order into a market, based on the received or generated order;
(iii) an out-of-band risk monitoring computer for monitoring the processing of the received or generated order in real time, calculating a risk parameter corresponding to the received or generated order, and updating the risk parameter; and
(iv) a kill-switch positioned in-line between said component and said gateway and coupled to said computer, for preventing orders from reaching the market based on the updated risk parameter.

2. The system of claim 1, wherein the kill-switch is enabled to prompt an operation chosen from a list of operations comprising: (i) a gateway cancel-on-disconnect operation; (ii) re-routing an order to a in-line risk monitoring system; (iii) communicating a termination signal to a market center; (iv) selectively blocking or filtering subsequent network packets; or (v) one or more combinations thereof

3. The system of claim 1, further comprising a warning signal wherein said warning signal is used to indicate the occurrence of an event.

4. The system of claim 3, wherein the event is chosen from a list of events comprising: (i) a gateway cancel-on-disconnect; (ii) meeting or exceeding a preset warning threshold; (iii) order cancelation; (iv) re-routing an order; (v) communicating a termination signal; (vi) selectively blocking or filtering subsequent network packets; or (vii) combinations thereof

5. The system of claim 3, wherein the warning signal is communicated via a processor based device.

6. The system of claim 2, wherein the operation is triggered when the difference between the updated risk parameter and a maximum risk parameter is less than or equal to a maximum risk parameter that may be incurred by the next order.

7. A computer implemented method for providing zero latency risk monitoring comprising:
receiving or generating an order;
placing an order in a market, the order corresponding to the received or generated order;
monitoring processing of the order in real time;
using an out-of-band computer to calculate a real-time risk parameter corresponding to the monitored order;
updating the calculated real-time risk parameter; and
determining based on the updated real-time risk parameter whether to prevent orders from reaching the market.

8. The system of claim 7, further comprising the step of triggering a gateway cancel-on-disconnect operation of a kill-switch positioned in-line between the receiving step and the placing step.

9. The system of claim 7, further comprising the step of re-routing an order to a in-line risk monitoring system via a kill-switch positioned in-line between the receiving step and the placing step.

10. The system of claim 7, further comprising the step of communicating a termination signal to a market center via a kill-switch positioned in-line between the receiving step and the placing step.

11. The computer implemented method of claim 7, further comprising the step of indicating the occurrence of an event via a warning signal.

12. The computer implemented method of claim 11, wherein the event is chosen from a list of events comprising: (i) a gateway cancel-on-disconnect; (ii) meeting or exceeding a preset warning threshold; (iii) order cancelation; (iv) re-routing an order; (v) communicating a termination signal; (vi) selectively blocking or filtering subsequent network packets; or (vii) combinations thereof.

13. The computer implemented method of claim 11, further comprising the step communicating the warning signal via a processor based device.

14. A processor-based apparatus for providing zero latency risk monitoring comprising:
(i) a component for receiving an order;
(ii) a gateway for communicating an order into a market, based on the received order;
(iii) an out-of-band risk monitoring computer for monitoring the processing of the received order in real time, calculating a risk parameter corresponding to the received order, and updating the risk parameter; and
(iv) a kill-switch positioned in-line between said component and said gateway and coupled to said computer, for preventing orders from reaching the market based on the updated risk parameter.

15. The processor-based apparatus of claim 14, wherein the kill-switch is enabled to prompt an operation chosen from a list of operations comprising: (i) a gateway cancel-on-disconnect operation; (ii) re-routing an order to a in-line risk monitoring system; (iii) communicating a termination signal to a market center; (iv) selectively blocking or filtering subsequent network packets; or (v) one or more combinations thereof

16. The processor-based apparatus of claim 14, further comprising a warning signal wherein said warning signal is used to indicate the occurrence of an event.

17. The processor-based apparatus of claim 16, wherein the event is chosen from a list of events comprising: (i) a gateway cancel-on-disconnect; (ii) meeting or exceeding a preset warning threshold; (iii) order cancelation; (iv) re-routing an order; (v) communicating a termination signal; (vi) selectively blocking or filtering subsequent network packets; or (vii) combinations thereof

18. The processor-based apparatus of claim 16 wherein the warning signal is communicated via a processor based device.

19. The processor-based apparatus of claim 15, wherein the operation is triggered when the difference between the updated risk parameter and a maximum risk parameter is less than or equal to a maximum risk parameter that may be incurred by the next order.

20. A processor-based system for providing zero latency risk monitoring comprising:
(i) a component for receiving or generating an order;
(ii) a gateway for communicating an order into a market, based on the received or generated order;
(iii) an out-of-band risk monitoring computer for monitoring the processing of the received or generated order in real time, calculating a risk parameter corresponding to the received or generated order, and updating the risk parameter;
(iv) a kill-switch positioned in-line between said component and said gateway and coupled to said computer, for preventing orders from reaching the market; and
(v) a secondary connection capable of bypassing an enabled kill-switch for communicating an order to a gateway for entry into an exchange, wherein an in-line risk management system enabled to calculate and update a risk parameter evaluates the order prior to communication to said gateway.

21. The processor-based system of claim 20, wherein the kill-switch is enabled to prompt an operation chosen from a list of operations comprising: (i) a gateway cancel-on-disconnect operation; (ii) re-routing an order to a in-line risk monitoring system via the secondary connection; (iii) communicating a termination signal to a market center; (iv) selectively blocking or filtering subsequent network packets; or (v) one or more combinations thereof.

22. The processor-based system of claim 20, further comprising a warning signal wherein said warning signal is used to indicate the occurrence of an event.

23. The processor-based system of claim 22, wherein the event is chosen from a list of events comprising: (i) a gateway cancel-on-disconnect; (ii) meeting or exceeding a preset warning threshold; (iii) order cancelation; (iv) re-routing an order; (v) communicating a termination signal; (vi) selectively blocking or filtering subsequent network packets; or (vii) combinations thereof.

24. The processor-based system of claim 22, wherein the warning signal is communicated via a processor based device.

25. The processor-based system of claim 21, wherein the operation is triggered when the difference between the updated risk parameter and a maximum risk parameter is less than or equal to a maximum risk parameter that may be incurred by the next order.

26. A computer implemented method for providing zero latency risk monitoring comprising:
receiving or generating an order;
placing an order in a market, the order corresponding to the received or generated order;
monitoring processing of the order in real time;
using an out-of-band computer to calculate a real-time risk parameter corresponding to the monitored order;
updating the calculated real-time risk parameter;
determining based on the updated real-time risk parameter whether to prevent orders from reaching the market, and optionally trigger a gateway cancel-on-disconnect operation of a kill-switch positioned in-line between the receiving step and the placing step;
evaluating a second order using an in-line risk management system enabled to calculate and update a real-time risk parameter; and
communicating the second order to a gateway for entry into a market via a secondary connection capable of bypassing an enabled kill-switch.

27. The computer implemented method of claim 26, further comprising the step of triggering a gateway cancel-on-disconnect operation of a kill-switch positioned in-line between the receiving step and the placing step.

28. The computer implemented method of claim 26, further comprising the step of re-routing an order to a in-line risk monitoring system via a kill-switch positioned in-line between the receiving step and the placing step.

29. The computer implemented method of claim 26, further comprising the step of communicating a termination signal to a market center via a kill-switch positioned in-line between the receiving step and the placing step.

30. The computer implemented method of claim 26, further comprising the step of indicating the occurrence of an event via a warning signal.

31. The computer implemented method of claim 30, wherein the event is chosen from a list of events comprising: (i) a gateway cancel-on-disconnect; (ii) meeting or exceeding a preset warning threshold; (iii) order cancelation; (iv) re-routing an order; (v) communicating a termination signal; or (vi) combinations thereof

32. The computer implemented method of claim 30, further comprising the step communicating the warning signal via a processor based device.

33. The computer implemented method of claim 26, wherein the gateway cancel-on-disconnect operation is triggered when the difference between the updated risk parameter and a maximum risk parameter is less than or equal to a maximum risk parameter that may be incurred by the next order.

34. A system for providing zero latency risk monitoring comprising:
(i) a component for receiving or generating an order;
(ii) an out-of-band risk monitoring computer for monitoring the processing of the received or generated order in real time, calculating a risk parameter corresponding to the received or generated order, and updating the risk parameter; and
(iii) a kill-switch positioned in-line between said component and a market and coupled to said computer, for preventing orders from being executed in the market based on the updated risk parameter.

35. The system of claim 34, wherein the kill-switch is enabled to prompt an operation chosen from a list of operations comprising: (i) a gateway cancel-on-disconnect operation; (ii) re-routing an order to a in-line risk monitoring system; (iii) communicating a termination signal to a market center; or (iv) one or more combinations thereof
